(19) United States
(12) Patent Application Publication
(10) Pub. No.: US 2026/0208175 A1
(43) Pub. Date: Jul. 23, 2026

(54) PHOTOCATALYTIC PASTE, A HIGHLY ACTIVE AND STABLE POROUS MATERIAL WITH PHOTOCATALYTIC PROPERTIES FOR PURIFYING AIR FROM VOLATILE ORGANIC COMPOUNDS, INORGANIC COMPOUNDS AND MICROORGANISMS, AND A METHOD OF PRODUCING THEREOF

(71) Applicant: NANOSCI SPOLKA Z OGRANICZONA ODPOWIEDZIALNOSCIA, Warszawa (PL)

(72) Inventors: Adriana ZALESKA-MEDYNSKA, Warszawa (PL); Pawel MAZIERSKI, Warszawa (PL); Adam KADZIELA, Warszawa (PL); Bartosz SROKA, Warszawa (PL)

(73) Assignee: NANOSCI SPOLKA Z OGRANICZONA ODPOWIEDZIALNOSCIA, Warszawa (PL)

(21) Appl. No.: 19/136,973

(22) PCT Filed: Nov. 30, 2023
(86) PCT No.: PCT/IB2023/062069

§ 371 Date: Jun. 9, 2025

(30) Foreign Application Priority Data
Dec. 14, 2022 (PL) P.443156

(51) Int. Cl. B01J 35/39; B01J 21/06; B01J 35/23; B01J 35/66; B01J 37/02; B01J 37/04; B01J 37/06; B01J 37/08; B01J 37/34

(52) U.S. Cl. CPC B01J 35/39; B01J 21/063; B01J 35/23; B01J 35/66; B01J 37/0236; B01J 37/04; B01J 37/06; B01J 37/08; B01J 37/343

(57) ABSTRACT

The invention relates to a paste with photocatalytic properties for purifying the air from volatile organic compounds, inorganic compounds, microorganisms, in particular toluene, formaldehyde, NOₓ, SO₂ and Psedomonas aeruginosa bacteria from the air, as well as porous materials having a layer of photocatalytic paste and a method of producing thereof. The invention is used to remove volatile organic compounds, inorganic compounds and pathogenic microorganisms suspended in the air, such as bacteria, fungi, fungal spores and viruses. The invention is used especially in devices for deodorization and purification of air streams for photocatalytic removal of microorganisms and volatile organic compounds, stationary and portable devices for purification and deodorization of air in closed rooms (homes, offices, sports halls, medical facilities), in window devices, in devices built into air conditioning systems. The invention is used to purify the air from volatile organic compounds (VOCs), inorganic compounds such as toluene, formaldehyde, NOₓ and SO₂, NH₃ and microorganisms—bacteria, fungi, fungal spores, viruses.

The invention relates to a paste with photocatalytic properties for purifying the air from volatile organic compounds, inorganic compounds, microorganisms, in particular toluene, formaldehyde, NOₓ, SO₂ and Psedomonas aeruginosa bacteria from the air, as well as porous materials with a layer of photocatalytic paste and a method of producing thereof. The invention is used to remove volatile organic compounds, inorganic compounds and pathogenic microorganisms suspended in the air, such as bacteria, fungi, fungal spores and viruses. The invention is used especially in devices for deodorization and purification of air streams for photocatalytic removal of microorganisms and volatile organic compounds, stationary and portable devices for purification and deodorization of air in closed rooms (homes, offices, sports halls, medical facilities), in window devices, in devices built into air conditioning systems. The invention is used to purify the air from volatile organic compounds (VOCs), inorganic compounds such as toluene, formaldehyde, NOₓ and SO₂, NH₃ and microorganisms—bacteria, fungi, fungal spores, viruses.

There are known methods of producing layers with photocatalytic properties, which involve the deposition of titanium dioxide on a matrix. Devices for purifying air from organic and inorganic odors and microorganisms are known, in which a layer with a photocatalytic material is installed.

A system for photocatalytic indoor air purification is known from the US application no. 5835840. A thin layer of titanium dioxide was applied to the inner surface of the ventilation duct. The system uses lamps emitting ultraviolet light.

A system for photocatalytic air purification in closed rooms is known from US patent description no. 007255831. A photocatalyst made of titanium dioxide modified with tungsten (VI) oxide is used. The tungsten-modified photocatalyst was obtained by adding a TiO₂ suspension to an aqueous solution. Then, the obtained photocatalyst was dispersed in water in an amount of 25% by weight and applied to the surface of the honeycomb substrate by electrophoretic spraying or immersion. In the process of producing thin layers of photocatalyst, the homogenization process of WO₃/TiO₂ nanoparticles in water was used, which should last from 10 to 30 minutes.

From US patent description no. U.S. Ser. No. 00/6797127, an air purification system is known, which consists of UV light sources. The degradation process of pollutants takes place in the presence of a titanium dioxide photocatalyst with an orthorhombic structure modified with silver, gold, platinum, tungsten, vanadium, or copper. The photocatalyst was deposited on the surface of a metal plate, ceramic substrate, polyester fibers, paper, plastic, or paper filter.

From PL223973, a device for the photocatalytic removal of volatile organic pollutants is known, consisting of a plate element on which a photocatalytic layer is applied and a carrier element on which a light source in the form of LED diodes emitting UV light, preferably UV-A and/or or UV-C, and the light source is directed towards the photocatalytic layer. The photocatalytic layer is made of a photocatalyst consisting of metal-modified titanium dioxide nanotubes. It was reported that the TiO₂-based photocatalytic layer was modified with platinum. The photocatalyst was obtained by adding an aqueous solution of potassium hexachloroplatinate (IV) to alcohol. Then, the titanium dioxide precursor tetraisopropyl titanate (TIP) was added. The obtained sol was dried at 80° C. and calcined at 450° C. for 3 hours. Then, the photocatalyst was deposited by immersion on the surface of the ceramic material and placed in the device as a plate element.

From P.417116, porous coatings composed of a ceramic bed or nanotubes and titanium oxide or titanium oxide modified with platinum and quantum dots are known. Titanium oxide is applied in the form of a paste by immersion and then drying and calcining. TiO₂—Pt is obtained by reducing K₂PtCl₄ introduced into a suspension of TiO₂ in an alcohol solution and then adding a reducer—NaBH₄. The resulting TiO₂—Pt precipitate is washed with water and ethanol and dried.

From P.433102, a colloidal dispersion system is known—a paste containing from 1 to 60% by weight (preferably from 2 to 36% by weight) of TiO₂ particles: a mixture of anatase with rutile in a weight ratio from 65:45 to 90:10, with sizes from 10⁻⁹ to 10⁻⁵ m, preferably from 10⁻⁸ to 10⁻⁷ μm. The paste also contains a nonionic surfactant from 1 to 20% by weight (preferably 1.6 to 18% by weight) including mixtures of polyoxyethylene derivatives of sorbitan and oleic acid (Tween 80), coconut oil acids polyglucoside, decyl glucoside, polyethylene glycol (PEG) and p-tert-octylphenol (Triton X-100), lauryl glucoside, disodium cocoamphodiacetate (Disodium Cocoyl), polyoxyethylene lauryl ether (10) (Laureth-10), polyoxyethylene lauryl ether (23) (Laureth-23), and polyoxyethylene lauryl ether 4 (Laureth-4), preferably p-tert-octylphenol (Triton X-100), polymer in the amount of 1 to 20% by weight (preferably 5 to 13% by weight) of the type PVP (poly(vinylpyrrolidone), PEG (poly(ethylene oxide)), PVA (poly(vinyl alcohol)), preferably from the polyether group such as poly(ethylene oxide) with molecular weight from 200 to 20000 (preferably from 200 to 1000), solvent from 40 to 95% by weight, preferably in the range 65-95% by weight (polar solvents such as water, methyl, ethyl, propyl, isopropyl, butyl, tert-butyl alcohol, preferably isopropanol, ethanol, methanol, and their mixtures) and a pH adjusting agent from 1 to 5% by weight (preferably from 1.5 to 2.7% by weight) such as hydrochloric acid, nitric acid, sulfuric acid, acetic acid, formic acid, potassium hydroxide, ammonia and their mixtures in weight ratios of TiO₂:surfactant:polymer:solvent:pH adjusting agent from 0.025:0.025:0.025:1:0.025 to 3:1:1:4.75:0.25, viscosity from 0.001 to 40 Pa-s at 25° C. A porous material with photocatalytic properties for air purification from harmful volatile organic compounds, inorganic compounds, and microorganisms is also described. The porous material used includes silicon carbide, titanium carbide, tungsten carbide, silicon nitride, boron nitride, titanium nitride, aluminosilicates such as halloysite, zirconium oxide, aluminum oxide, or their mixtures with porosity ranging from 10 to 50 pores per inch (ppi). The preferred thickness of the porous material is from 1 to 50 mm (preferably from 2 to 30 mm), and the porous material is evenly covered with the paste. The ratio of the thickness of the photocatalytic layer to the porous material ranges from 0.00005:1 to 0.002:1. This results in beneficial effects. The ratio of the thickness of the paste layer to the thickness of the porous material is chosen such that the thickness of the porous material should range from 0.001 to 0.05 μm. Preferably, the thickness of the photocatalytic layer loaded on the surface of the porous material should be from 5·10⁻⁸ to 10⁻⁴ μm. In examples, a porous material with a photocatalytic paste layer applied has been described, with the layer thickness ranging from 5·10⁻⁸ to 10⁻⁴ μm and the thickness of the porous material being 0.001 and 0.05 m, and 2 and 30 mm.

A method of producing a material with photocatalytic properties for air purification through a developed method of applying pastes to a porous material is described.

The porous material used is a ceramic material such as silicon carbide, titanium carbide, tungsten carbide, silicon nitride, boron nitride, titanium nitride, aluminosilicates, e.g. halloysite, zirconium oxide, aluminum oxide or their mixture with a porosity of 10 to 50 ppi.

The disadvantages of known solutions in the field of photocatalytic materials for air purification are the toxicity of the synthetic adhesive agents used, most often in the form of polymers and non-ionic surfactants (e.g. Triton X-100, poly(vinylpyrrolidone), polyethylene glycol), the high cost and toxicity of organic solvents (e.g. ethyl, propyl, methyl, isopropyl, butyl, tert-butyl alcohol) used to produce photocatalytic layers, unstable bonding of the photocatalyst grains with the matrix surface, reduction of the photocatalytic activity of the obtained layers in subsequent measurement cycles. A significant disadvantage is that known pastes and photocatalytic materials with photocatalytic layers are not sufficiently resistant to vibrations and mechanical stimuli and at the same time do not demonstrate high efficiency in pollutant degradation. The known porous layers with photocatalytic paste are unstable and not very active.

The aim of the invention was to develop a paste, porous photocatalytic materials and a method for producing a photocatalytic paste and porous materials overcoming these disadvantages. The aim was to reduce the costs of layer production by up to approximately 30%, to develop a technology for applying a photocatalytic layer to selected stable matrices, and the research focused on those selected on the basis of previous research in order to obtain a photocatalytic layer resistant to vibrations or mechanical stimuli and at the same time showing high effectiveness. such as:
porous ceramic materials based on SiC with the addition of SiO₂ or MgO and/or CaO,
porous ceramic materials based on Al₂O₃ base with the addition of SiO₂ or MgO and/or CaO,
porous ceramic materials based on ZrO₂ base with the addition of SiO₂ or MgO and/or CaO,
porous metal materials made of titanium, copper, silver, nickel, steel, or aluminum,
porous ceramics made from Al₂O₃ with the addition of MgO and SiO₂, having a honeycomb structure with straight channels,
porous material made of glass fiber, graphene foam, or polyurethane foam.

The present invention seeks to provide a selected composition of the paste in terms of quality and quantity, free of toxic substances (including organic solvents), resistant to vibrations or mechanical stimuli and at the same time showing high effectiveness, and a method of obtaining an air purification material—a porous material with an applied TiO₂-based paste.

Therefore, the quantitative and qualitative composition of the photocatalytic paste based on TiO₂ was developed in the form of e.g. commercial P25 or anatase or rutile or a mixture of anatase and rutile used in an amount from 2% to 30% by weight of the total paste mass. The present invention proposes the use of chitosan in a paste and a cross-linking agent, which proved to be the most effective in the tests, i.e. in the form of aspartic acid or ascorbic acid or acetic acid or citric acid or formic acid or sodium citrate or oxalic acid, preferably aspartic acid or citric acid, acetic acid or oxalic acid and the ratio of chitosan to crosslinking agent is from 10:1 to 1:20, especially 1:2, 1:4 and 1:5. Chitosan in the paste ranges from 0.40 to 43.5% by weight in relation to the amount of TiO2 used, and the cross-linking agent from 0.4 to 87% by weight in relation to the amount of TiO₂ used. Chitosan is used with a low molecular weight, i.e. a maximum of 100,000, a medium molecular weight, i.e. from 100,000 to 300,000, and a high molecular weight of at least 300,000. The remaining ingredients are water, and the ratio of water to the cross-linking agent is from 1.5:50 to 1.5:1000.

The method of producing the paste is that 3 components of the paste, i.e. a cross-linking agent in the form of aspartic acid or ascorbic acid or acetic acid or citric acid or formic acid or sodium citrate or oxalic acid, preferably aspartic acid or citric acid or acetic acid or oxalic acid in amounts from 2% to 30% by weight to the weight of the entire final 4-component paste, chitosan in an amount from 0.40 to 43.5% by weight in relation to the amount of TiO₂ used in the next stage, and water in relation to the crosslinking agent from 1.5:50 to 1.5:1000, and the ratio of chitosan to the cross-linking agent is from 10:1 to 1:20, especially 1:2, 1:4 and 1:5, thoroughly combined, i.e. homogenized by intensive mixing combined with the use of ultrasound at room temperature or increased to 70° C., e.g. 30, 50 and 70° C. for a period of 5 to 300 min, e.g. 30 min, until a uniform consistency is achieved. How to obtain the appropriate consistency of a 3-component homogeneous base—TiO₂ is added to the base thus obtained in an amount from 2% to 30% by weight to the entire final 4-component paste and recombined, e.g. by homogenization in an analogous way, i.e. by intensive stirring supported by ultrasound for at least 2 hours to thoroughly mix all ingredients.

The invention also relates to the final porous material with photocatalytic properties for purifying the air from harmful volatile organic compounds, inorganic compounds and microorganisms with a non-transferred layer of autocatalytic paste. The following types of material are used as porous material:
1. Porous ceramic materials based on SiC with the addition of SiO₂ or MgO and/or CaO, with pore sizes ranging from 10 to 50 pores per inch (ppi), e.g., 10 or 20 or 30 or 40 or 50 ppi.
2. Porous ceramic materials based on Al₂O₃ with the addition of SiO₂ or MgO and/or CaO, with pore sizes ranging from 10 to 50 ppi, e.g., 10 or 20 or 30 or 40 or 50 ppi.
3. Porous ceramic materials based on ZrO₂ with the addition of SiO₂ or MgO and/or CaO, with pore sizes ranging from 10 to 50 ppi, e.g. 10 or 20 or 30 or 40 or 50 ppi.
4. Porous metallic materials with pore sizes ranging from 5 to 130 ppi (e.g. 5 or 30 or 80 or 130 ppi), made of titanium, silver, copper, nickel, steel, or aluminum.
5. Porous ceramics made of Al₂O₃ with the addition of MgO and SiO₂, having a honeycomb structure with straight channels and a cell-to-channel ratio (CPSI—cells per square inch) ranging from 100 to 600, e.g., 100 or 200 or 300 or 400 or 600.
6. Porous material made from graphene foam or fiberglass or polyurethane foam with pore sizes ranging from 100 to 2000 μm, e.g., 100 or 500 or 1000 or 2000 μm.

Preferably, the materials mentioned from 1) to 5) are used.

The porous material is covered with at least one layer of the paste described above. The ratio of the thickness of the photocatalytic layer to the porous material is from 3:500,000 to 1:10,000, and the porous material is evenly covered with the pastes mentioned above. Preferably, the thickness of the porous material is from 0.005 to 0.05 μm. Preferably, the thickness of the paste covering of the porous material is from 3·10⁻⁸ to 5·10⁻⁶ μm.

The invention also relates to a method for producing the final porous material with at least one layer of photocatalytic paste based on TiO₂, which consists of four stages: (1) producing a photocatalytic paste with the appropriate composition—this stage is described above; (2) application of the photocatalytic paste to one of the previously mentioned porous materials (from 1 to 6) with pore sizes ranging from 5 to 130 ppi (e.g. 5 or 30 or 80 or 130 ppi) or from 100 to 2000 μm, ensuring the ratio of the thickness of the photocatalytic layer to the porous material ranges from 3:500000 to 1:10000. Different thicknesses of the paste are deposited depending on the porous support and photocatalytic paste, i.e., for ceramic materials—from 3·10⁻⁸ to 5·10⁻⁶ m, for porous metal materials—from 3·10⁻⁸ to 5·10⁻⁷ m, for porous materials made from graphene foam or glass fiber or polyurethane foam—from 1·10⁻⁷ to 2·10⁻⁶ m. Before applying the photocatalytic paste, the surface of porous materials is cleaned by immersing them in a solvent mixture of 1:1 water/methanol and treated with ultrasound from 1 to 300 min (e.g. 15 min) and dried at a temperature of 40 to 150° C. (e.g. 60° C.) for 0.5 to 24 h (e.g. 6 h). In the case of porous metal materials made of titanium, silver, copper, nickel, steel, or aluminum, they are additionally subjected to an oxidation process after cleaning at a temperature of 50 to 600° C. (e.g. 400° C.) for 1 to 24 h (e.g. 12 h) to improve the deposition of the photocatalytic paste on their surface. The cleaned and dried porous materials are completely immersed in the photocatalytic paste for 0.5 to 300 min until the components of the photocatalytic paste bind to the surface of the porous material (e.g. 5 min) and treated with ultrasound—this process prevents the formation of aggregates, clogging of pores, and results in a uniform photocatalytic layer; (3) in the next stage, excess paste is removed by blowing the porous matrices with the applied paste with a stream of inert gas or subjected to centrifugal force and vibration until the excess paste is completely removed; (4) the photocatalytic layers prepared in this way are subjected to thermal treatment—dried at temperatures from 45 to 120° C., e.g. 60° C. for 6 to 12 hours, e.g. 6 hours and heated at a temperature of 400 to 500° C. until the organic substances were removed, from 0.5 to 24 hours, e.g. 2 hours for mineralization/removal of organic substances and for stable binding of the photocatalyst on the matrix surface.

The advantages of the invention relate to an efficient method of producing photocatalytic pastes, highly efficient porous photocatalytic materials for air purification from volatile organic compounds, inorganic compounds and microorganisms. The advantages of the invention include resistance to vibrations or mechanical stimuli and, at the same time, high efficiency and stability, as well as a method of producing a material for air purification—a porous material with a TiO₂-based paste applied.

Photocatalytic pastes are homogeneous mixtures that can be easily applied to porous materials—obtaining a durable, environmentally friendly, highly effective product.

The invention is described in more detail in the embodiments and shown in the drawings, in which:

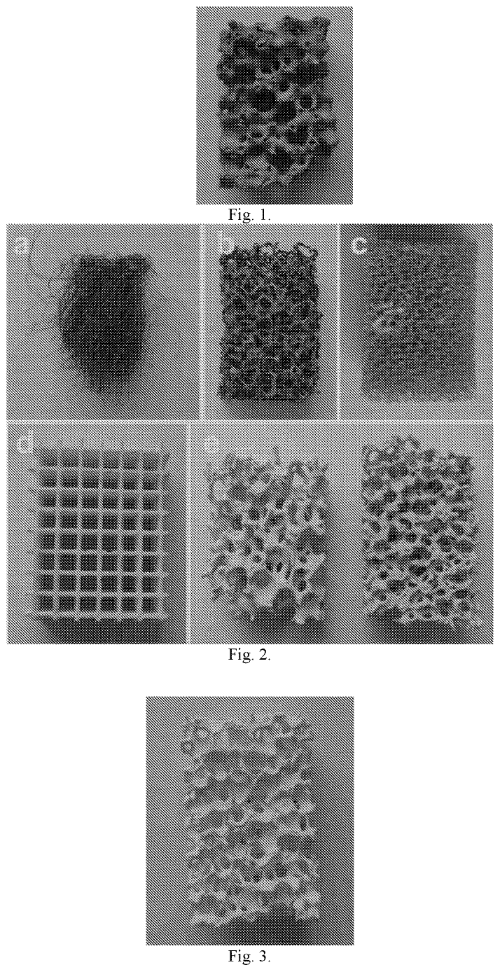

FIG. 1 shows a photo of a layer with photocatalytic properties composed of the paste 23TiO2_0.25Ch_0.5K_230W (the abbreviations used relating to the quantity are explained in the embodiment) deposited on a SiC matrix with a porosity of 20 ppi.

FIG. 2 shows a photo of photocatalytic layers produced by applying the paste designated as 23TiO2_0.25Ch_0.5K_230W on various types of matrices: a—steel matrix, b—copper matrix, c—polyurethane sponge, d—Al₂O₃ matrix with the addition of MgO and SiO₂ with a honeycomb structure with straight channels, e—ZrO₂ matrix with a porosity of 20 ppi (left) and 40 ppi (right).

FIG. 3 shows a photo of the photocatalytic layer produced by applying the paste designated as 23TiO2_0.25Ch_0.5K_230W cube made of Al₂O₃ (with 30 ppi porosity).

### EMBODIMENT 1

Methodology for Producing TiO₂-Based Pastes with Photocatalytic Properties

In order to develop the invention, experimental tests were carried out on many paste compositions made from selected ingredients. Based on these tests, the final composition of the invention was developed—where the expected effects were achieved.

Producing TiO₂-Based Pastes with Photocatalytic Properties, i.e. Combining Paste Ingredients:

The paste ingredients, including chitosan of different molecular weights, a cross-linking agent (aspartic acid or ascorbic acid or citric acid or acetic acid or formic acid or sodium citrate or oxalic acid) and water (i.e. 3 ingredients) are homogenized, i.e. thoroughly mixed through intensive stirring combined with ultrasound at room or elevated temperature (30, 50 and 70° C.) for 30 minutes until a uniform consistency is achieved. Then, an appropriate amount of TiO₂ is added to the 3-element homogeneous base and homogenized again in a similar way, i.e. by intensive ultrasonic-assisted stirring for 2 hours.

### Optimization of the Amount of Water to the Amount of Chitosan

In the initial stage, an attempt was made to produce a paste with photocatalytic properties, the paste including chitosan, aspartic acid, TiO₂ in the form of commercial P25 or anatase or rutile or a mixture of anatase and rutile and various amounts of water from 50 to 1000 ml. The quantitative and qualitative composition of these pastes is presented in Table 1.

TABLE 1
The quantitative and qualitative composition of
photocatalytic pastes with varying water content

| | Chitosan | Aspartic | | Water |
|---|---|---|---|---|
| Paste designation | (g) | acid (g) | TiO₂ (g) | (ml) |
| 23TiO₂_1Ch_1.5K_50W | 1 | 1.5 | 23 | 50 |
| 23TiO₂_1Ch_1.5K_100W | | | | 100 |
| 23TiO₂_1Ch_1.5K_200W | | | | 200 |
| 23TiO₂_1Ch_1.5K_230W | | | | 230 |
| 23TiO₂_1Ch_1.5K_500W | | | | 500 |
| 23TiO₂_1Ch_1.5K_1000W | | | | 1000 |

The explanation of the sample labels is provided using the example of 23TiO2_1Ch_1.5K_230W: 23TiO₂— the number before TiO₂ refers to the amount of TiO₂ used in (g), 1Ch-Ch stands for chitosan, and the number before it indicates the amount used in (g), 1.5K-K represents acid, and the number before it indicates the amount used in (g), 230W-W stands for water, and the number before it indicates the amount used in (ml).

All pastes exhibited an appropriate consistency. The best consistency was observed in sample 23TiO2_1Ch_1.5K_230W, where 230 ml of water was used to produce the paste. This paste underwent further modifications, described below.

Optimization of the amount of aspartic acid to the amount of chitosan

In order to reduce the costs of paste production and to obtain photocatalytic layers of appropriate thickness and mechanical and vibration resistance in the next stage, an attempt was made to reduce and increase the amount of aspartic acid in the paste. Pastes containing various amounts of aspartic acid from 0.1 to 20 g were produced, the exact composition of which is presented in Table 2.

TABLE 2
The quantitative and qualitative composition of photocatalytic
pastes with varying content of aspartic acid

| | Chitosan | Aspartic | | Water |
|---|---|---|---|---|
| Paste designation | (g) | acid (g) | TiO₂ (g) | (ml) |
| 23TiO₂_1Ch_0.1K_230W | 1 | 0.1 | 23 | 230 |
| 23TiO₂_1Ch_0.5K_230W | | 0.5 | | |
| 23TiO₂_1Ch_1K_230W | | 1 | | |
| 23TiO₂_1Ch_2K_230W | | 2 | | |
| 23TiO₂_1Ch_10K_230W | | 10 | | |
| 23TiO₂_1Ch_20K_230W | | 20 | | |

Optimization of the Amount and Molecular Weight of Chitosan in Paste with Photocatalytic Properties

In order to further optimize the composition of the paste, an attempt was made to reduce and increase the amount of chitosan in the paste from 0.1 to 10 g. Table 3 shows the composition of pastes with different amounts of chitosan, including the addition of 1 g of aspartic acid as a polysaccharide cross-linking agent for each amount.

TABLE 3
The quantitative and qualitative composition of pastes with
photocatalytic properties with varying amount of chitosan

| | Chitosan | Aspartic | TiO₂ | Water |
|---|---|---|---|---|
| Paste signature | (g) | acid (g) | (g) | (ml) |
| 23TiO₂_0.1Ch_1K_230W | 0.1 | 1 | 23 | 230 |
| 23TiO₂_0.25Ch_1K_230W | 0.25 | | | |
| 23TiO₂_0.5Ch_1K_230W | 0.5 | | | |
| 23TiO₂_1Ch_1K_230W | 1 | | | |
| 23TiO₂_2Ch_1K_230W | 2 | | | |
| 23TiO₂_5Ch_1K_230W | 5 | | | |
| 23TiO₂_10Ch_1K_230W | 10 | | | |

In the next step, the impact of the molecular weight of chitosan on the properties of the pastes was examined. Table 4 shows the compositions of pastes with different molecular weights of chitosan. All pastes had the appropriate consistency, the pastes differed in viscosity, which in the next step affected the thickness of the photocatalytic layer deposited on the porous matrices.

TABLE 4
The composition of pastes along with their qualitative and quantitative
composition depending on the molecular weight of chitosan

| | Composition of paste | | | | |
|---|---|---|---|---|---|
| | | | Amount of | Molecular | Aspartic |
| | TiO₂ | Water | of chitosan | weights of | acid |
| Paste designation | (g) | (ml) | (g) | chitosan | (g) |
| 23TiO2_5Ch_1K_230W | 23 | 230 | 0.25 | Low 50 000, | 0.25 |
| | | | | 100 000 | |
| 23TiO2_5Ch_1K_230W | | | | Medium | |
| | | | | 100 000, | |
| | | | | 300 000 | |
| 23TiO2_5Ch_1K_230W | | | | High 300 000, | |
| | | | | 1 000 000, | |
| | | | | 1 500 000 | |

### Optimization of the Amount of TiO₂ in the Developed Paste Composition

The next stage of research on the composition of the paste with photocatalytic properties was to optimize the amount of TiO₂ in the paste. Table 5 shows the compositions of new pastes containing TiO₂ in amounts of 3, 23, 28, 33 and 38 g along with their remaining composition.

TABLE 5
The composition of pastes along with their qualitative and quantitative
composition depending on the amount of added TiO₂

| | Composition of paste | | | |
|---|---|---|---|---|
| | | | | Aspartic |
| | TiO₂ | Water | Chitosan | acid |
| Paste designation | (g) | (ml) | (g) | (g) |
| 3TiO₂_0.25Ch_0.5K_230W | 3 | 230 | 0.25 | 0.5 |
| 23TiO₂_0.25Ch_0.5K_230W | 23 | | | |
| 28TiO₂_0.25Ch_0.5K_230W | 28 | | | |
| 33TiO₂_0.25Ch_0.5K_230W | 33 | | | |
| 38TiO₂_0.25Ch_0.5K_230W | 38 | | | |

In the next stage, the impact of the type of chitosan cross-linking agent on the properties of pastes with photocatalytic properties was examined. For this purpose, aspartic acid was replaced in a 1:1 ratio with ascorbic acid or citric acid or acetic acid or formic acid or sodium citrate or oxalic acid. A homogeneous paste was obtained when all crosslinking agents were used, especially aspartic acid, citric acid, acetic acid and oxalic acid.

Based on these data, the compositions of pastes with the best effects were determined.

### EMBODIMENT 2

Methodology for obtaining photocatalytic layers on porous matrices based on developed paste compositions.

### Applying Photocatalytic Paste to Porous Matrices:

First, porous matrices detailed in Example 5 made of ceramic materials or porous metal materials made of titanium, copper, silver, nickel, steel, aluminum or straight channel porous honeycomb ceramics or porous material made of fiberglass or foam graphene or polyurethane foam were cleaned by immersing them in a mixture of solvents in a 1:1 water/methanol ratio and exposed to ultrasound for e.g. 15 min and dried at a temperature from 40 to 150° C., e.g. 40 or 60 or 100 or 150° C. for 0.5 to 24 hours, e.g. 0.5 or 3 or 6 or 24 hours. In the case of porous metal materials made of titanium or silver or copper or nickel or steel or aluminum, they are additionally subjected to an oxidation process after cleaning at a temperature of 50 to 600° C., e.g. 50 or 100 or 400 or 600° C. for 1 to 24 hours, e.g. 1 or 6 or 12 or 24 hours to improve the deposition of the photocatalytic paste on their surface. The cleaned and dried porous matrices are completely immersed in the photocatalytic paste for 0.5 to 300 min, e.g. 0.5 or 30 or 75 or 100 or 300 min, until the components of the photocatalytic paste bind on the surface of the porous matrices, e.g. 5 min and exposed to ultrasound—this process prevents the formation of aggregates, clogging of pores and creates a homogeneous photocatalytic layer.

The ratio of the thickness of the photocatalytic layer to the porous material was from 3:500,000 to 1:10,000, e.g. 3:500,000 or 1:20,000 or 1:10,000, and the porous material was evenly covered with photocatalytic pastes. Preferably, the thickness of the porous material is from 0.005 to 0.05 m, e.g. 0.005 or 0.01 or 0.05 m. Preferably, the thickness of the paste covering of the porous material is from 3·10⁻⁸ to 5·10⁻⁶ m, e.g. 3·10⁻⁸ or 5·10⁻⁷ or 5·10⁻⁶ μm.

Optimization of the thermal treatment process A selected SiC matrix with a porosity of 30 ppi, impregnated with a paste composed of 23 g of TiO2, 0.25 g of chitosan, 0.5 g of aspartic acid, 230 ml of water, was dried and calcined in the developed range at various temperatures and times in order to estimate the effect of thermal treatment on efficiency of toluene photodegradation in the presence of the obtained photocatalytic layers and to determine the cost of thermal treatment. The photocatalytic layers were dried in a dryer at 45-120° C. for 6-12 hours and heated at 400-500° C. until the organic substances were removed from 0.5 to 24 hours, e.g. 0.5 or 2 or 12 or 24 hours to mineralization/removal of organic substances and to stably bind the photocatalyst on the matrix surface.

### EMBODIMENT 3

Testing the efficiency of toluene removal from the gas phase in a closed photoreactor in the presence of photocatalytic layers deposited on a SiC matrix

### Research Methodology

All obtained photocatalytic layers were tested in a model reaction of toluene degradation in the gas phase in a closed photoreactor. The process was carried out in a steel photoreactor equipped with two valves, the connector closed with a septum and the top with quartz glass sealed with Teflon gaskets pressed with screws. First, the photocatalytic layer was placed in the reactor and closed tightly, then air containing a toluene concentration of 200 ppm (flow rate 30 dm³/h) was passed through the reactor for 1 min. After this time, the reactor valves were closed, through which toluene gas was passed, and the system was left for 15 min to establish the adsorption-desorption equilibrium between the photocatalyst particles and toluene molecules. After 15 ma, a sample was taken through the septum in the reactor after 0, 5, 10, 15, 20, 25 and 30 min with a gas syringe. The injections had a volume of 200 μL and were analyzed using a gas chromatograph with an FID detector. The LEDs (λₘₐₓ=375 nm) were turned on after the adsorption-desorption equilibrium was established, immediately after taking sample 0.

### Results

The results of photocatalytic activity in static tests using a model toluene degradation reaction in the presence of photocatalytic layers obtained on the basis of the pastes described in Example 1 are presented in Table 6.

TABLE 6
Results of photocatalytic degradation of toluene (C₀ = 200 ppm) from the
gas phase in the presence of photocatalytic layers loaded on a SiC support (30 ppi)

| | | | | | The |
|---|---|---|---|---|---|
| | | | | | efficiency |
| | | | | | of toluene |
| | | | | | degradation |
| | | | | | after 30 |
| | Composition of the pastes used to produce photocatalytic layers | | | | min of |
| | | Aspartic acid | TiO₂ | Water | irradiation |
| Sample label | Chitosan (g) | (ml) | (g) | (ml) | (%) |
| 23TiO₂_1Ch_1.5K_50W | 1 | 1.5 | 23 | 50 | 44 |
| 23TiO₂_1Ch_1.5K_100W | | | | 100 | 45 |
| 23TiO₂_1Ch_1.5K_200W | | | | 200 | 55 |
| 23TiO₂_1Ch_1.5K_230W | | | | 230 | 91 |
| 23TiO₂_1Ch_1.5K_500W | | | | 500 | 80 |
| 23TiO₂_1Ch_1.5K_1000W | | | | 1000 | 64 |
| 23TiO₂_1Ch_0.1K_230W | 1 | 0.1 | 23 | 230 | 82 |
| 23TiO₂_1Ch_0.5K_230W | | 0.5 | | | 80 |
| 23TiO₂_1Ch_1K_230W | | 1 | | | 82 |
| 23TiO₂_1Ch_2K_230W | | 2 | | | 76 |
| 23TiO₂_1Ch_10K_230W | | 10 | | | 50 |
| 23TiO₂_1Ch_20K_230W | | 20 | | | 53 |
| 23TiO₂_0.1Ch_1K_230W | 0.1 | 1 | 23 | 230 | 88 |
| 23TiO₂_0.25Ch_1K_230W | 0.25 | | | | 96 |
| 23TiO₂_0.5Ch_1K_230W | 0.5 | | | | 84 |
| 23TiO₂_1Ch_1K_230W | 1 | | | | 72 |
| 23TiO₂_2Ch_1K_230W | 2 | | | | 82 |
| 23TiO₂_5Ch_1K_230W | 5 | | | | 90 |
| 23TiO₂_10Ch_1K_230W | 10 | | | | 90 |
| 23TiO₂_0.25Ch_1K_230W | 0.25 g, low | 1 | 23 | 230 | 90 |
| | molecular | | | | |
| | weight | | | | |
| 23TiO₂_0.25Ch_1K_230W | 0.25 g, | | | | 95 |
| | medium | | | | |
| | molecular | | | | |
| | weight | | | | |
| 23TiO₂_0.25Ch_1K_230W | 0.25 g, high | | | | 97 |
| | molecular | | | | |
| | weight | | | | |
| 3TiO2_0.25Ch_0.5K_230W | 0.25 | 0.5 | 3 | 230 | 76 |
| 23TiO2_0.25Ch_0.5K_230W | | | 23 | | 97 |
| 28TiO2_0.25Ch_0.5K_230W | | | 28 | | 64 |
| 33TiO2_0.25Ch_0.5K_230W | | | 33 | | 83 |
| 38TiO2_0.25Ch_0.5K_230W | | | 38 | | 83 |

On this basis, the best quantitative and qualitative composition was developed. The highest photocatalytic activity was demonstrated by the SiC layer with the 23TiO2_0.25Ch_0.5K 230W paste applied. The efficiency of toluene degradation in this case was 97% after 30 min of reaction. High efficiency was also attributed to the remaining photocatalytic layers produced, which constitute the invention.

SiC matrices with a porosity of 30 ppi, impregnated with a paste composed of 23 g of TiO₂, 0.25 g of chitosan, 0.5 g of aspartic acid, 230 ml of water, were dried and calcined at various temperatures and times in order to estimate the impact of thermal treatment on the efficiency of toluene photodegradation in the presence of the obtained photocatalytic layers. Table 7 presents the results obtained for photocatalytic layers dried in a dryer at 45-120° C. for 6-12 hours and heated at 400-500° C. until organic substances are removed from 0.5 to 24 hours, e.g. 0.5 or 2 or 12 or 24 hours to mineralize/remove organic substances and to stably bind the photocatalyst on the matrix surface. Based on the data obtained, it can be concluded that the best thermal treatment conditions are: drying at 60° C. for 6 hours and heating at 400° C. for 2 hours.

TABLE 7
Results of photodegradation of toluene in the presence of photocatalytic layers
produced under various thermal conditions. Conditions for the toluene degradation process:
static process in a 35 cm³ photoreactor, toluene C₀ = 200 ppm

| | | | The |
|---|---|---|---|
| | | | efficiency |
| | | | of toluene |
| | | | degradation |
| | | | after 30 |
| | | | min of |
| | Drying and calcination conditions | | irradiation |
| Paste signature | Drying | Calcination | (%) |
| 23TiO2_0.25Ch_0.5K_230W_45_Cal | 45° C. | 450° C. | 81 |
| | for ~12 h | for 2 h | |
| 23TiO2_0.25Ch_0.5K_230W_60_Cal | 60° C. | 450° C. | 96 |
| | for ~12 h | for 2 h | |
| 23TiO2_0.25Ch_0.5K_230W_80_Cal | 80° C. | 450° C. | 88 |
| | for ~12 h | for 2 h | |
| 23TiO2_0.25Ch_0.5K_230W_100_Cal | 100° C. | 450° C. | 93 |
| | for ~12 h | for 2 h | |
| 23TiO2_0.25Ch_0.5K_230W_120_Cal | 120° C. | 450° C. | 84 |
| | for ~12 h | for 2 h | |
| 23TiO2_0.25Ch_0.5K_230W_120_WithoutCal | 120° C. | — | 5 |
| | for ~12 h | | |
| 23TiO2_0.25Ch_0.5K_230W_100_1h_Cal | 100° C. | 450° C. | 79 |
| | for 1 h | for 2 h | |
| 23TiO2_0.25Ch_0.5K_230W_200_12h_WithoutCal | 100° C. | — | 49 |
| | for 1 h | | |
| 23TiO2_0.25Ch_0.5K_230W_300_12h_WithoutCal | 300° C. | — | 55 |
| | for 12 h | | |
| 23TiO2_0.25Ch_0.5K_230W_dry_6h_60*C_Cal_{—} | 60° C. | 450° C. | 83 |
| 450* C_2h | for 6 h | for 2 h | |
| 23TiO2_0.25Ch_0.5K_230W_dry_12h_60*C_Cal_{—} | 60° C. | 450° C. | 96 |
| 450* C_2h | for 12 h | for 2 h | |
| 23TiO2_0.25Ch_0.5K_230W_dry_6h_60*C_Cal_{—} | 60° C. | 400° C. | 98 |
| 400* C_2h | for 6 h | for 2 h | |
| 23TiO2_0.25Ch_0.5K_230W_dry_6h_60*C_Cal_{—} | 60° C. | 500° C. | 95 |
| 500* C_2h | for 6 h | for 2 h | |
| 23TiO2_0.25Ch_0.5K_230W_dry_6h_60*C_Cal_{—} | 60° C. | 400° C. | 95 |
| 400* C_0.5h | for 6 h | for 0.5 h | |
| 23TiO2_0.25Ch_0.5K_230W_dry_6h_60*C_Cal_{—} | 60° C. | 400° C. | 90 |
| 400* C_12h | for 6 h | for 12 h | |
| 23TiO2_0.25Ch_0.5K_230W_dry_6h_60*C_Cal_{—} | 60° C. | 400° C. | 90 |
| 400* C_24h | for 6 h | for 24 h | |

### EMBODIMENT 4

### Optimization of the Number of Paste Layers on the Matrix

It was checked whether multiple application of photocatalytic paste increases the efficiency of toluene photodegradation. For this purpose, a SiC cube with a porosity of 30 ppi was impregnated with 23TiO2_0.25Ch_0.5K_230W paste, dried (60° C. for 12 hours) and impregnated with the paste again—obtaining a double layer. Then, this process was repeated 4, 6, and 20 times, thus obtaining photocatalytic layers of various thicknesses of TiO₂. Then, each produced layer was standardly calcined at 400° C. for 2 hours (temperature increase of 10°/min). The layers produced in this way were tested in a model toluene degradation reaction according to the methodology described in Embodiment 3. The photodegradation of toluene in the presence of photocatalytic layers with photocatalytic paste applied 2, 4, 6 and 20 times was 98.6, 98.5, 98 and 55%, respectively, and with a single one 96.6%. This indicates that only applying the paste 20 times to the porous matrix worsens the photocatalytic properties of the layers.

### EMBODIMENT 5

### Optimization of Matrix Types

The paste with the composition 23TiO2_0.25Ch_0.5K_230W and in the developed range was applied to selected matrices other than the previously used SiC with a porosity of 30 ppi.

For this purpose, porous matrices made of the following were used:
1. Porous ceramic materials based on SiC with the addition of SiO₂ or MgO and/or CaO, with pore sizes ranging from 10 to 50 pores per inch (ppi), e.g. 10 or 20 or 30 or 40 or 50 ppi.
2. Porous ceramic materials based on Al₂O₃ with the addition of SiO₂ or MgO and/or CaO, with pore sizes ranging from 10 to 50 ppi, e.g., 10 or 20 or 30 or 40 or 50 ppi.
3. Porous ceramic materials based on ZrO₂ with the addition of SiO₂ or MgO and/or CaO, with pore sizes ranging from 10 to 50 ppi, e.g. 10 or 20 or 30 or 40 or 50 ppi.
4. Porous metallic materials with pore sizes ranging from 5 to 130 ppi (e.g. 5 or 30 or 80 or 130 ppi), made of titanium or silver or copper or nickel or steel or aluminum.
5. Porous ceramics made of Al₂O₃ with the addition of MgO and SiO₂, having a honeycomb structure with straight channels and a cell-to-channel ratio (CPSI—cells per square inch) ranging from 100 to 600, e.g. 100 or 200 or 300 or 400 or 600.
6. Porous material made from graphene foam or fiberglass or polyurethane foam with pore sizes ranging from 100 to 2000 μm, e.g. 100 or 500 or 1000 or 2000 μm.

The thickness of the tested porous matrices was 5, 10, 20 or 50 mm. The thickness of the photocatalytic layers to the porous material ranged from 3:500,000 to 1:10,000. Depending on the matrix and photocatalytic paste, different paste thicknesses are deposited on it, i.e. for ceramic materials—from 3·10⁻⁸ to 5·10⁻⁶ m, e.g. 3·10⁻⁸ or 10⁻⁷ or 5·10⁻⁶ m; for porous metallic materials—from 3·10⁻⁸ to 5·10⁻⁷ m, e.g. 3·10⁻⁸ or 10⁻⁷ or 5·10⁻⁷ m; for porous material made of graphene foam or fiberglass or polyurethane foam—from 1·10⁻⁷ to 2·10⁻⁶ m, e.g. 1·10⁻⁷ or 1.5·10⁻⁶ or 2·10⁻⁶ m. After applying the paste, all matrices were subjected to a previously optimized two-stage thermal treatment: drying for 6 hours at 60° C. and calcining for 2 hours at 400° C. (temperature increase of 10° C./min). The exceptions were the polyurethane matrix and metal matrices made of titanium or silver or copper or nickel or steel or aluminum. In the case of polyurethane matrices, after applying the paste, the layer was dried at 100° C. for 12 hours. In the case of porous metal materials made of titanium or silver or copper or nickel or steel or aluminum, they are additionally subjected to an oxidation process after cleaning at a temperature of 50 to 600° C., e.g. 400° C. for 1 to 24 hours, e.g. 12 hours to improve the deposition of the photocatalytic paste on their surface. FIG. 1 shows a photo of a photocatalytic layer produced on a SiC matrix with a porosity of 20 ppi—a photo showing a layer with photocatalytic properties composed of 23TiO2_0.25Ch_0.5K_230W paste deposited on a SiC matrix with a porosity of 20 ppi.

The activity of photocatalytic layers produced by applying the selected paste to other previously indicated types of matrices was also tested. Photos of selected porous matrices with embedded photocatalytic paste are presented in FIG. 2—a photo of photocatalytic layers created by applying paste designated as 23TiO2_0.25Ch_0.5K_230W on various types of matrices: a—steel matrix, b —copper matrix, c—polyurethane sponge, d—Al₂O₃ with the addition of MgO and SiO₂ with a honeycomb structure with straight channels, e—ZrO₂ matrix with a porosity of 20 ppi (left) and 40 ppi (right).

All produced photocatalytic layers were tested in the toluene degradation reaction in the gas phase (C₀=200 ppm), and the results for selected photocatalytic layers in three tests are presented in Table 8.

TABLE 8
Photoactivity results of photocatalytic layers with
23TiO2_0.25Ch_0.5K_230W paste deposited on various
types of matrices. Conditions for the toluene
degradation process: static process in a
35 cm³ photoreactor, toluene C₀ = 200 ppm

| | | Measure- | Measure- | Measure- |
|---|---|---|---|---|
| | Irradiation | ment | ment | ment |
| | time | I | II | III |
| Type of matrix | (min) | Toluene degradation efficiency (C/C₀) | | |
| Steel matrix | 0 | 0 | 0 | 0 |
| | 10 | 75 | 78 | 80 |
| | 20 | 100 | 95 | 100.0 |
| | 30 | — | 100.0 | — |
| Copper matrix | 0 | 0 | 0 | 0 |
| | 10 | 13 | 17 | 23 |
| | 20 | 25 | 26 | 26 |
| | 30 | 34 | 35 | 21 |
| Polyurethane | 0 | 0 | 0 | 0 |
| foam | 10 | 10 | 11 | 8 |
| | 20 | 21 | 23 | 19 |
| | 30 | 34 | 37 | 35 |
| Al₂O₃ with the | 0 | 0 | 0 | 0 |
| addition of | 10 | 80 | 68 | 44 |
| MgO and SiO₂ | 20 | 96 | 87 | 61 |
| with a | 30 | 100 | 95 | 72 |
| honeycomb | | | | |
| structure with | | | | |
| straight | | | | |
| channels | | | | |
| ZrO₂ support | 0 | 0 | 0 | 0 |
| with a porosity | 10 | 41 | 58 | 0 |
| of 20 ppi | 20 | 60 | 70 | 9 |
| | 30 | 72 | 81 | 32 |
| ZrO₂ support | 0 | 0 | 0 | 0 |
| with a porosity | 10 | 49 | 57 | 64 |
| of 40 ppi | 20 | 72 | 80 | 85 |
| | 30 | 85 | 92 | 95 |

Average efficiency of toluene degradation after 30 min exposure was 100%, 80%, 34%, 89%, 92%, 90% for the paste deposited on a steel matrix, copper matrix, polyurethane sponge, Al₂O₃ with the addition of MgO and SiO₂ with a honeycomb structure with straight channels, ZrO₂ matrix, respectively with the addition of SiO₂, MgO and CaO with a porosity of 20 ppi and a ZrO₂ matrix with the addition of SiO₂ and MgO with a porosity of 40 ppi. Very high efficiency was also attributed to the photocatalytic layer produced on porous Al₂O₃ ceramic matrices with the addition of SiO₂ or MgO/CaO, porous matrices made of titanium, silver, copper, nickel, steel, aluminum, graphene foam, glass fiber, to which the invention is related. For all matrices, the toluene degradation efficiency was >80%, except for polyurethane foam, where the toluene degradation efficiency was 34%. A photo of the photocatalytic layer produced on porous Al₂O₃ matrices with the addition of SiO₂ and MgO/CaO is shown in FIG. 3—Photo of the photocatalytic layer created by applying a paste with the signature 23TiO2_0.25Ch_0.5K_230W onto an Al₂O₃ cube (porosity 30 ppi).

### EMBODIMENT 6

### Testing the Stability of the Produced Layers in a Static Test

The stability measurement was intended to determine how the produced photocatalytic layers behave after many cycles of toluene degradation. The stability test consisted of 10 repetitions of toluene degradation. The toluene concentration used in the processes was 50 ppm. The tested photocatalytic layer was placed in the reactor, blown with toluene for 1 minute, the valves were closed and left for 15 minutes to establish adsorption-desorption equilibrium. After equilibrium was established, three zero samples were taken and then the system was irradiated with LED diodes using UVA radiation for 30 minutes. After irradiation, samples were taken after 30 minutes. Then, the valves in the reactor were opened and the system was blown out using a pump and at the same time irradiated for 30 minutes—the cube regeneration stage. After completing the regeneration process, another toluene degradation process was carried out. The mentioned procedure was performed 10 times. The results of testing the stability of photocatalytic layers on an Al₂O₃ matrix with 23TiO2_0.25Ch_0.5K_230W paste allow us to conclude that the photocatalytic layers show unchanged activity after each repetition. The test results are presented in Table 9. A similar conclusion can be drawn for other selected materials.

TABLE 9
Results of stability tests of Al₂O₃ cubes
with 23TiO2_0.25Ch_0.5K_230W paste.
Conditions for the toluene degradation process: static
process in a 35 cm³ photoreactor, toluene
C₀ = 50 ppm.

| | | Cube 1 | Cube 2 | Cube 3 |
|---|---|---|---|---|
| Repetition | Irradiation | (Al₂O₃) | (Al₂O₃) | (Al₂O₃) |
| number | time (min) | Toluene degradation efficiency (C/C₀) | | |
| Repetition 1 | 0 | 0 | 0 | 0 |
| | 3 | 1 | 1 | 1 |
| | 0 | 0 | 0 | 0 |
| | | 0 | 0 | 0 |
| Repetition 2 | 0 | 0 | 0 | 0 |
| | 3 | 1 | 1 | 1 |
| | 0 | 0 | 0 | 0 |
| | | 0 | 0 | 0 |
| Repetition 3 | 0 | 0 | 0 | 0 |
| | 3 | 1 | 1 | 1 |
| | 0 | 0 | 0 | 0 |
| | | 0 | 0 | 0 |
| Repetition 4 | 0 | 0 | 0 | 0 |
| | 3 | 1 | 1 | 1 |
| | 0 | 0 | 0 | 0 |
| | | 0 | 0 | 0 |
| Repetition 5 | 0 | 0 | 0 | 0 |
| | 3 | 1 | 1 | 1 |
| | 0 | 0 | 0 | 0 |
| | | 0 | 0 | 0 |
| Repetition 6 | 0 | 0 | 0 | 0 |
| | 3 | 1 | 1 | 1 |
| | 0 | 0 | 0 | 0 |
| | | 0 | 0 | 0 |
| Repetition 7 | 0 | 0 | 0 | 0 |
| | 3 | 1 | 1 | 1 |
| | 0 | 0 | 0 | 0 |
| | | 0 | 0 | 0 |
| Repetition 8 | 0 | 0 | 0 | 0 |
| | 3 | 1 | 1 | 1 |
| | 0 | 0 | 0 | 0 |
| | | 0 | 0 | 0 |
| Repetition 9 | 0 | 0 | 0 | 0 |
| | 3 | 1 | 1 | 1 |
| | 0 | 0 | 0 | 0 |
| | | 0 | 0 | 0 |
| Repetition 10 | 0 | 0 | 0 | 0 |
| | 3 | 1 | 1 | 1 |
| | 0 | 0 | 0 | 0 |
| | | 0 | 0 | 0 |

1. Photocatalytic paste for air purification from volatile organic compounds, inorganic compounds and microorganisms containing TiO₂, water and a cross-linking agent, wherein that TiO₂ is in an amount from 2% to 30% by weight of the total paste mass, and aspartic acid or ascorbic acid or acetic acid or citric acid or formic acid or sodium citrate or oxalic acid is used as a cross-linking agent, preferably aspartic acid or citric acid or acetic acid or oxalic acid, the paste further containing chitosan in an amount such that the ratio of chitosan to the cross-linking agent is from 10:1 to 1:20, especially 1:2, 1:4 and 1:5, and the chitosan in the paste is in an amount from 0.40 to 43.5% by weight in relation to the amount of TiO₂ used, and the cross-linking agent ranges from 0.4 to 87% by weight in relation to the amount of TiO₂ used, wherein the chitosan used is one with a low molecular weight or medium molecular weight or high molecular weight, and wherein the paste contains water in such an amount that the ratio of water to the cross-linking agent is from 1.5:50 to 1.5:1000.

2. A method for obtaining a photocatalytic paste for air purification from volatile organic compounds, inorganic compounds and microorganisms containing TiO₂, water and a cross-linking agent, wherein by preparing the base by mixing a cross-linking agent being an aspartic acid or ascorbic acid or acetic acid or citric acid or formic acid or sodium citrate or oxalic acid, preferably ascorbic acid or citric acid or acetic acid or oxalic acid in an amount from 2% to 30% by weight of the total paste mass, chitosan in an amount from 0.40 to 43.5% by weight in relation to the amount of TiO₂ used in the next step, and water in relation to the cross-linking agent from 1.5:50 to 1.5:1000, and the ratio of chitosan to the cross-linking agent is from 10:1 up to 1:20, especially 1:2, 1:4 and 1:5, preferably homogenized by intensive stirring combined with ultrasound until a uniform consistency is obtained, and after obtaining a homogeneous mixture, TiO₂ is added to the base thus obtained in an amount of 2% to 30% by weight to the total paste mass and stirred again, preferably by ultrasonic-assisted homogenization, until all paste ingredients are thoroughly mixed.

3. A highly active and stable porous material with photocatalytic properties for purifying the air from harmful volatile organic compounds, inorganic compounds and microorganisms, covered with a photocatalytic paste containing TiO₂, water and a cross-linking agent, wherein that the porous material used is such as:
porous ceramic material based on SiC with the addition of SiO₂ or MgO and or CaO with a pore size from 10 to 50 ppi, or
porous ceramic material based on Al₂O₃ with the addition of SiO₂ or MgO and/or CaO with a pore size from 10 to 50 ppi, or
porous ceramic material based on ZrO2 with the addition of SiO₂ or MgO and/or CaO with a pore size from 10 to 50 ppi, or
porous metal material with pore sizes from 5 to 130 ppi made of titanium or silver or copper or nickel or steel or aluminum, or
porous ceramics made on the basis of Al₂O₃ with the addition of MgO and SiO₂ with a honeycomb structure and a cell ratio of porous material per square inch CPSI ranging from 100 to 600, or
a porous material made of graphene foam or glass fiber or graphene foam with a pore size from 100 to 2000 μm, wherein the porous material is covered with at least one layer of photocatalytic paste according to claim 1 so that the ratio of the thickness of the paste layer to the porous material is from 3:500000 to 1:10000 and the porous material is covered evenly, preferably the thickness of the porous material is from 0.005 to 0.05 m, and more preferably the thickness of the paste covering of the porous material is from 3·10⁻⁸ do 5·10⁻⁶ m.

4. A porous material according to claim 3, wherein the porous material is:
porous ceramic material based on SiC with the addition of SiO₂ or MgO and or CaO with a pore size from 10 to 50 ppi, or
porous ceramic material based on Al₂O₃ with the addition of SiO₂ or MgO and/or CaO with a pore size from 10 to 50 ppi, or
porous ceramic material based on ZrO₂ with the addition of SiO₂ or MgO and/or CaO with a pore size from 10 to 50 ppi, or
porous metal material with pore sizes from 5 to 130 ppi made of titanium or silver or copper or nickel or steel or aluminum, or
porous ceramics made based on Al₂O₃ with the addition of MgO and SiO₂ with a honeycomb structure and a cell ratio of porous material per square inch CPSI ranging from 100 to 600 or

5. A method for producing a highly active and stable porous material with photocatalytic properties for purifying the air from harmful volatile organic compounds, inorganic compounds and microorganisms, covered with a paste containing TiO₂, chitosan, water and a cross-linking agent, characterized by the following steps:
a. the photocatalytic paste is prepared according to the method according to claim 2;
b. the surface of the porous material is cleaned, dried and the paste is applied to the porous material by immersing it in the paste until the paste ingredients bind on the surface of the porous material and preferably is treated with ultrasound, and the porous material used is:
porous ceramic material based on SiC with the addition of SiO₂ or MgO and or CaO with a pore size from 10 to 50 ppi, or
porous ceramic material based on Al₂O₃ with the addition of SiO₂ or MgO and/or CaO with a pore size from 10 to 50 ppi, or
porous ceramic material based on ZrO₂ with the addition of SiO₂ or MgO and/or CaO with a pore size from 10 to 50 ppi, or
porous metal material with pore sizes from 5 to 130 ppi made of titanium or silver or copper or nickel or steel or aluminum, or
porous ceramics made based on Al₂O₃ with the addition of MgO and SiO₂ with a honeycomb structure and a cell ratio of porous material per square inch CPSI ranging from 100 to 600, or
porous material made of graphene foam or glass fiber or graphene foam with a pore size from 100 to 2000 μm,
so that the ratio of the thickness of the paste layer to the porous material is from 13:500000 to 1:10000, and in the case of porous metal materials made of titanium or silver or copper or nickel or steel or aluminum, after cleaning, they are additionally subjected to an oxidation process at a temperature from 50 to 600° C.;
then in the next step the excess paste is removed;
the photocatalytic layer prepared in this way on the porous material is subjected to a thermal treatment process.

6. A method according to claim 5, wherein that,
depending on the porous material, the thickness of the paste layer is applied on it such that for a ceramic material the thickness is from 3·10⁻⁸ to 5·10⁻⁶ m or for porous metal materials from 3·10⁻⁸ to 5·10⁻⁷ m, or for porous material made of graphene foam or glass fiber or graphene foam from 1·10⁻⁷ to 2·10⁻⁶ m.

7. A method according to claim 5, wherein that before depositing the paste, the porous material is cleaned by immersion in a water/methanol solvent mixture, preferably in a 1:1 ratio, and treated with ultrasound.

8. A method according to claim 5, wherein that after cleaning, the porous material is dried at a temperature of 40 to 150° C. for 0.5 to 24 hours.

9. A method according to claim 5, wherein that the prepared photocatalytic layer on the porous material is subjected to a thermal treatment process by drying at 45 to 120° C. for 6 to 12 hours and then heated at a temperature of 400 to 500° C. until the organic substances are removed and the layer is stably bound on the surface.
